(19) United States
(12) Patent Application Publication
(10) Pub. No.: US 2002/0040690 A1
(43) Pub. Date: Apr. 11, 2002

(54) Pet collar and leash assembly

(76) Inventor: Bradley M. Ganz, Portland, OR (US)

Correspondence Address: BRADLEY M GANZ, PC, P O BOX 10105, PORTLAND, OR, 97296

(21) Appl. No.: 09/929,207

(22) Filed: Aug. 13, 2001

Related U.S. Application Data
(60) Provisional application No. 60/224,764, filed on Aug. 12, 2000.

(51) Int. Cl. A01K 27/00

(52) U.S. Cl. 119/792

(57) ABSTRACT

This invention relates to a novel assembly of a pet collar for a dog or other animal and a leash. The collar has an integrated, closeable pouch for holding a leash. The leash may be permanently or removably affixed to an anchoring element within the pouch or otherwise on the collar. The pouch seals in a manner so that the leash is hidden, giving a normal appearance to the collar.

### BACKGROUND OF THE INVENTION

This application claims priority to provisional application Ser. No. 60/224,764 filed Aug. 12, 2000, the entire disclosure of which is incorporated by reference.

As much as we love them, our pets can be unpredictable and challenging. For example, many a dog owner knows the experience of their dog slipping through a narrowly opened door and heading down the street. What to do? Chase the dog with a leash in hand; apprehend the dog and drag or carry him or her back to the house? Or first look for the dog's leash, risking that the dog will have disappeared by the time the leash is found and chase can be given? This is a real problem that many dog owners have faced, and I speak from personal experience. It affects the safety and well being of the pet and even the owner. There simply has not been a good solution to this problem.

Another problem faced by pet owners who are runners or otherwise engage in outdoor activity is the inconvenience of carrying or storing a leash when it is not needed. For example, many people running with their dogs while on trails do not need to keep the leash on the dog. It is inconvenient and freedom restricting for the runner to carry the leash. And all but the best-trained dogs are incapable of helping in this Task. The leash, however, may be needed at a moment's notice, for example, when meeting other people or animals on the trail or when encountering roads with traffic. There simply is no adequate solution to this dilemma as well.

### SUMMARY OF THE INVENTION

The present invention overcomes these problems by providing a collar that can contain the leash. Preferably the leash is contained in a manner that does not detract substantially from the normal appearance of the collar. While containing the leash, the collar looks like a conventional dog collar and has no aesthetically displeasing aspects. In aesthetically containing the leash, the collar also keeps the animal safe from being tangled in the leash or catching the leash on environmental objects. The collar and leash assembly conveniently provides a closure system that allows easy access to the leash whenever needed. It also provides a means for comfortable grasping of the leash as well as easily returning the leash into its containment area in the collar. The leash may also be removably attached to the collar so, for example, it can be washed or replaced as needed.

More specifically, the present invention contemplates the following, non-limiting example embodiments:

An assembly of a collar and leash, the collar having a closeable pouch for storing the leash substantially integrated into the collar. The assembly may further includea handle element storable in the closeable pouch. The assembly may further include means for holding the leash, e.g. a winding element, insertable into the closeable pouch while holding the leash. The assembly may include a pouch that is substantially the same width as the collar and extends lengthwise along some or all the length of the collar.

In another possible embodiment, the present invention contemplates a restraining device for an animal having a closeable pouch for storing a leading means substantially integrated into the device, and anchoring means disposed on the device for connecting the leading means. The device may include a leading means connected to the anchoring means. The device may include a leading means that is a leash. The device may include be included on a harness. The device may include a leading means that includes a winding element. The device may include a closeable pouch that is disposed in a device comprising a collar for a dog, the pouch closing in a manner so that the collar appears substantially the same as a conventional collar.

In another possible embodiment, the present invention contemplates a method of making a restraining device for an animal, comprising: creating a closeable pouch for storing a leading means, the pouch being substantially integrated into a device for restraining an animal, disposing anchoring means on the device for connecting leading means. The method may further comprise the step of connecting a leading means to the anchoring means. In the method, the leading means may be a leash. In the method, the device may be included on a harness. In the method, the leading means may include a winding element. In the method, the closeable pouch may be disposed in a device comprising a collar for a dog, the pouch closing in a mariner so that the collar appears substantially the same as a conventional collar.

In the foregoing embodiments, the device may include a zipper for closing the pouch. In the foregoing embodiments, the winding element may comprise a flexible tube that may also serve as a handle for the leading means.

### DESCRIPTION OF THE DRAWINGS

FIG. 1 shows an overall view of a collar and leash assembly 10 according to the present invention.

FIG. 2 shows a partial view of the collar and leash assembly 10 of FIG. 1 with the attachment end of the leash 24 showing within a containment pouch 18 on collar 12.

FIG. 3 shows the collar and leash assembly 10 of FIG. 1 with a tubular handle/winding element 26 on the end of the leash 22 opposite the attachment end of the leash 24.

FIG. 4 shows an end view of handle 26 with leash 22 wound therearound.

FIG. 5 shows a lengthwise view of the handle 26 with leash 22 wrapped therearound.

FIG. 6 shows the collar and leash assembly 10 of FIG. 1 with leash 22 placed in pouch 18, in this case while wound around optional handle/winding element 26.

FIG. 7 shows the collar and leash assembly 10 of FIG. 6 with the leash enclosed within pouch 18.

### DESCRIPTION OF THE INVENTION

This invention relates to a novel assembly of a pet collar for a dog or other animal and a leash 10. The collar 12 has a closeable pouch 18 for holding a leash 22. The leash 22 may be permanently or removably affixed to an anchoring element within the pouch 13 or otherwise on the collar 12.

The leash element 22 may include a handle element 26 that also fits within the pouch 18 of the collar 12. The handle should be a thin, flexible material that fits within pouch 18. Preferably, the handle element 26 is a tubular element made of flexible plastic or rubber that fits over the leash 22. Preferably, the handle element 26 is also a winding element onto which the leash may be wound for easy insertion into the pouch 18 on the collar 12. For this purpose, the element 26 should have some rigidity but not so much that it will not take the contour of the pet's neck.

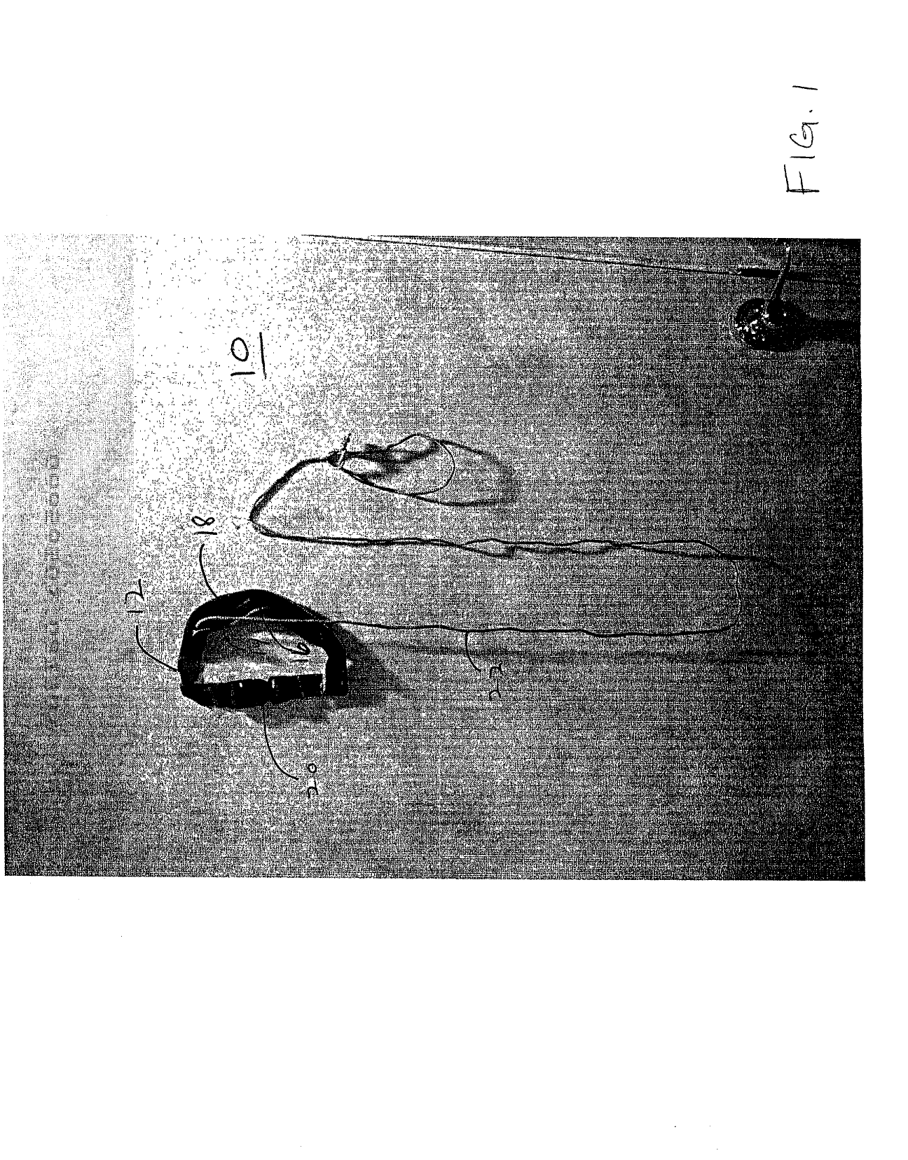

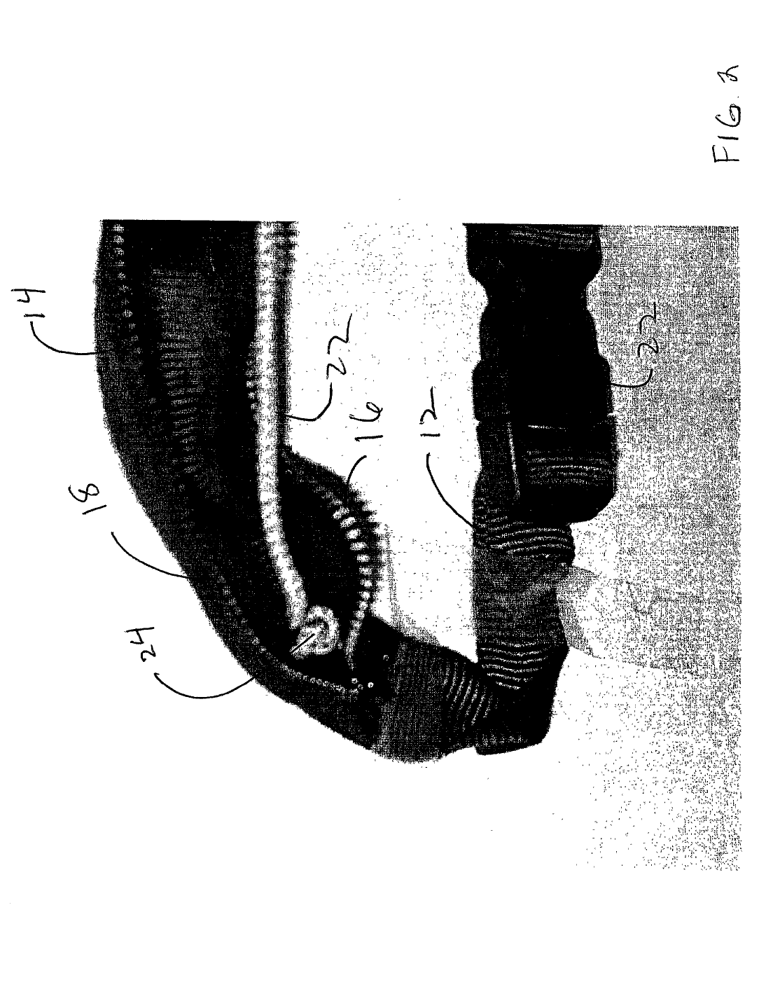

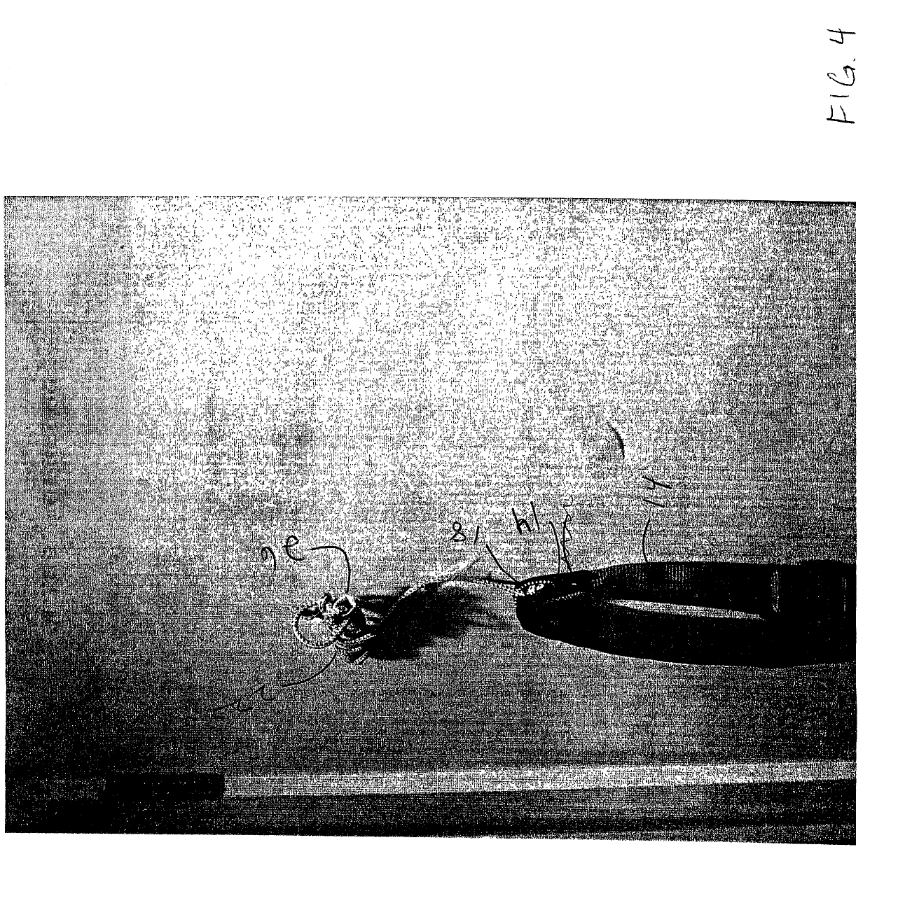

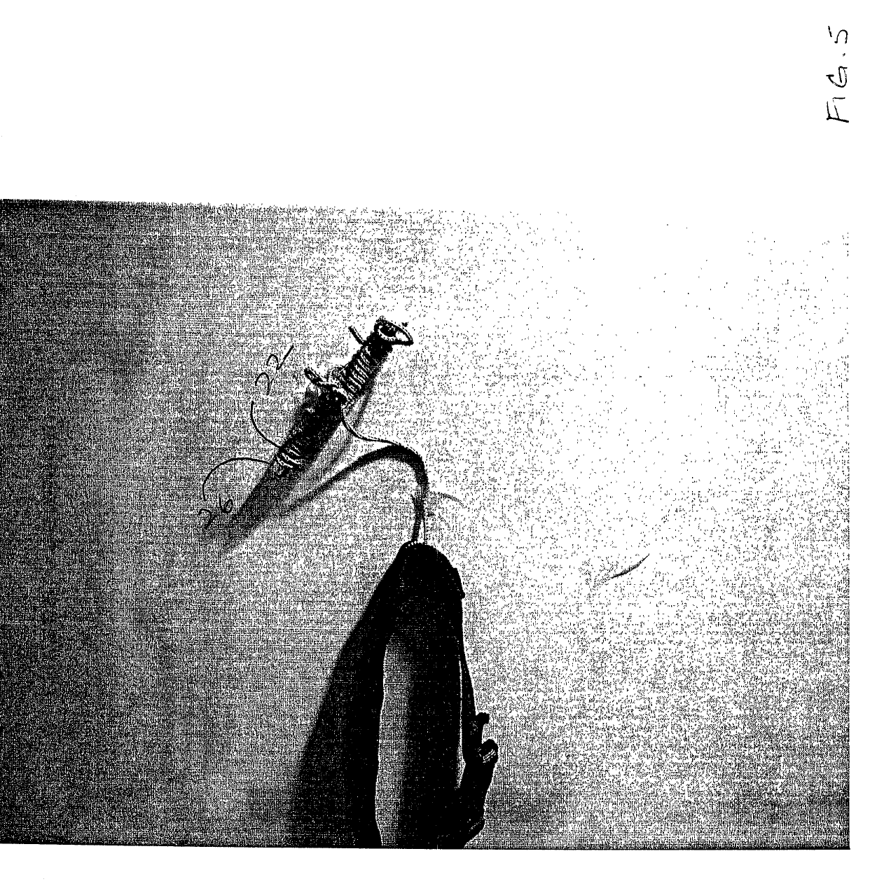

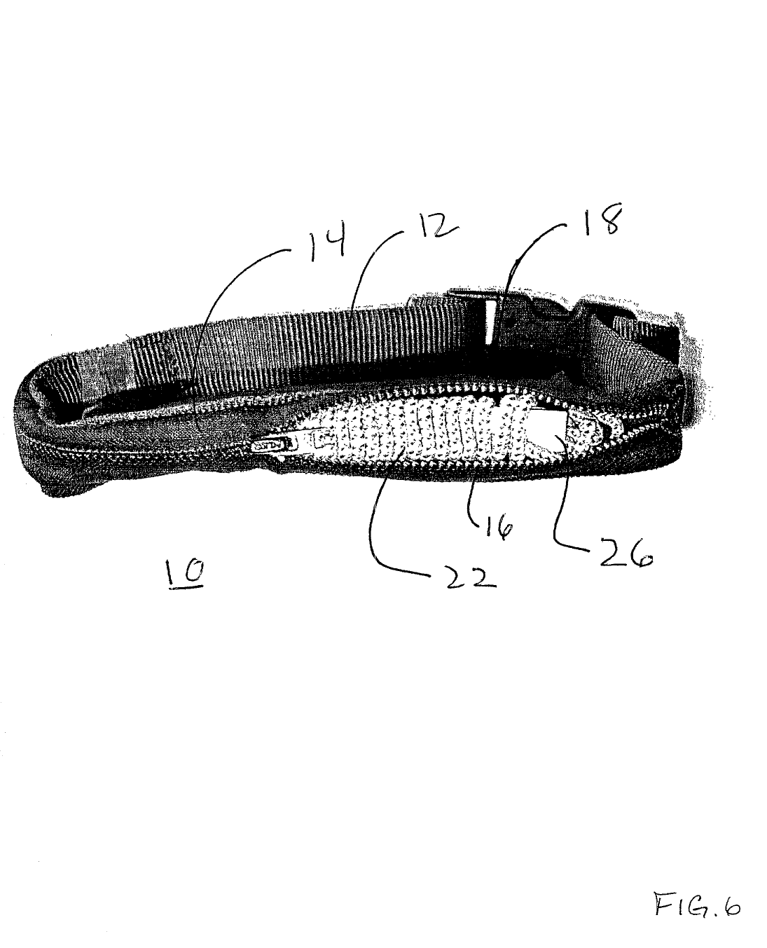

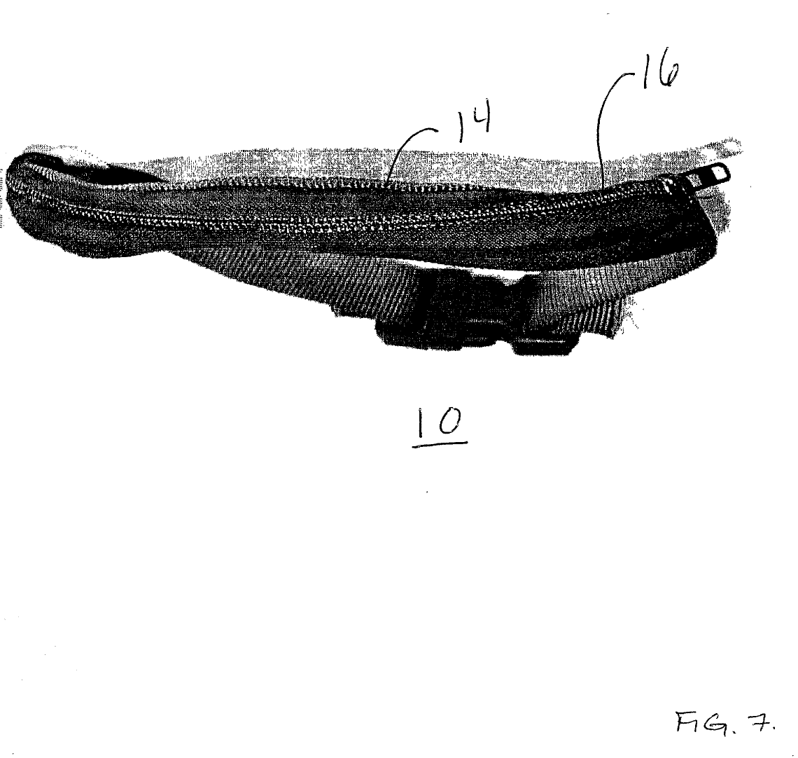

In a preferred embodiment, as shown in FIGS. 1-7, the collar and leash assembly 10 comprises a nylon strap or collar 12 onto which is stitched an overlying cover or strap 14 comprised of a thin nylon rope, with a closure means 16, such as a zipper, running along the length of the strap 14. Cover 14 should only be stitched along its edges to the edges of the collar. A closeable pouch 18 is formed by such an attachment of strap 14 having closure means 16 to collar 12. The closure means is not necessarily limited to a zipper, closure means may also be, for example, snaps or Velcro® as known in the art. At the ends of the collar 12, there is included a buckle assembly 20. Preferably, the collar is of a size and length of a conventional collar. Strap 14 may be about the same width as the collar, or slightly larger. By using a thin rope as a leash, the size and width of the collar/strap assembly may be kept to a minimum, so as to maintain the look of a conventional collar.

It is also contemplated that alternatives to strap 14 could be a tube or sleeve of material instead of a flat strap. Further, strap 14 could be provided as a single strip of material with a zippered opening or dual strips of materials with mating halves of the zipper, for example, on facing edges of the strips. It is also contemplated that the access openings for pouch 18 could be at either or both ends of the cover 14, in addition to or instead of a lengthwise opening, as shown in the Figures.

An end of the leash 24 may be removably or permanently affixed or stitched onto the collar 12 within the space of pouch 18 defined by the collar 12 and strap 14. Alternatively, there could be a metal ring, clip, clasp or other attachment means stitched or attached onto the collar 12 within the pouch 18 for receiving an end 24 of the leash 22 with a snap, clip, clasp or other means to make the leash removable. In one possible embodiment, such means extends from a closed pouch through an opening. The leash 22 may be made of a strap or other rope-like material as is known in the art. The leash 22 may also be made of stretchable cord materials. A thin nylon rope is particularly suitable because of its strength and durability, and because it does not add excessive bulk to the collar when enclosed in pouch 18.

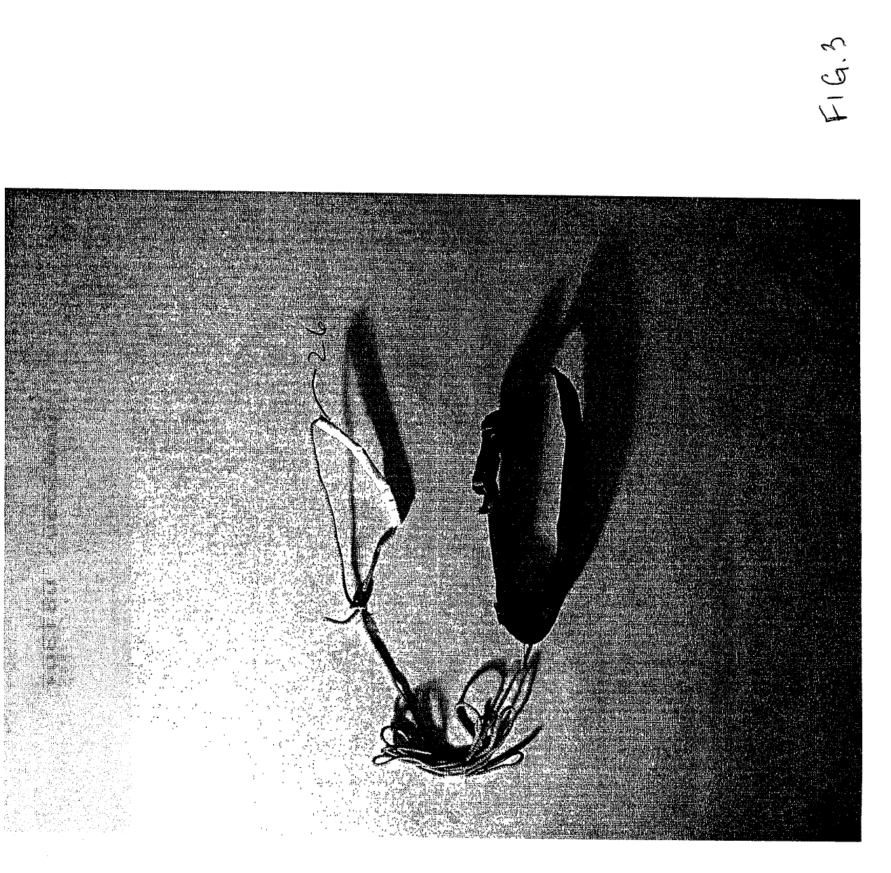

The leash 22 may optionally include a tubular handle member 26, as shown, so that the user of the leash may more comfortably grasp the leash. As shown in FIGS. 3-6, the handle 26 may alternatively serve as an element for wrapping or otherwise holding the leash 22 so that the leash 22 may more easily be inserted into the pouch 18.

In an alternative embodiment, the winding element comprises an anchoring element disposed within the pouch 18. For example, small hooks could be disposed at opposite ends of the pouch, the leash wound around the hooks. Such anchoring means could also be disposed on opposite ends of the handle to facilitate winding.

In addition to collars, it is contemplated that the present invention may also be used in similar restraining devices such as harnesses that include a collar portions, as well as in collaring, bridling, and like devices used for livestock and horses, the basic concept of the present invention being a leash or lead that stows in a closeable compartment on something worn by an animal.

The foregoing embodiments and features are for illustrative purposes and are not intended to be limiting persons skilled in the art capable of appreciating other embodiments from the scope and spirit of the foregoing teachings.

What is claimed:

1. An assembly of a collar and leash, the collar having a closeable pouch for storing the leash substantially integrated into the collar.

2. The assembly of claim 2 further including a handle element storable in the closeable pouch.

3. The assembly of claim 2 further including means for holding the leash, e.g. a winding element, insertable into the closeable pouch while holding the leash.

4. The assembly of claim 2 wherein the pouch is substantially the same width as the collar and extends lengthwise along some or all the length of the collar.

5. A restraining device for an animal having a closeable pouch for storing a leading means substantially integrated into the device, and anchoring means disposed on the device for connecting the leading means.

6. The device of claim 5 further comprising a leading means connected to the anchoring means.

7. The device of claim 5 wherein the leading means is a leash.

8. The device of claim 5 wherein the device is included on a harness.

9. The device of claim 6 wherein the leading means includes a winding element.

10. The device of claim 9 wherein the closeable pouch is disposed in a device comprising a collar for a dog, the pouch closing in a manner so that the collar appears substantially the same as a conventional collar.

11. A method of making a restraining device for an animal, comprising:
creating a closeable pouch for storing a leading means, the pouch being substantially integrated into a device for restraining an animal, disposing anchoring means on the device for connecting leading means.

12. The method of claim 11 further comprising the step of connecting a leading means to the anchoring means.

13. The method of claim 11 wherein the leading means is a leash.

14. The method of claim 11 wherein the device is included on a harness.

15. The method of claim 12 wherein the leading means includes a winding element.

16. The method of claim 15 wherein the closeable pouch is disposed in a device comprising a collar for a dog, the pouch closing in a manner so that the collar appears substantially the same as a conventional collar.

17. The device of claim 1 further including a zipper for closing the pouch.

18. The device of claim 5 further including a zipper for closing the pouch.

19. The device of claim 12 further including a zipper for closing the pouch.

20. The device of claim 5 wherein the winding element comprises a flexible tube that may also serve as a handle.
